(19) United States
(12) Patent Application Publication
(10) Pub. No.: US 2012/0223938 A1
(43) Pub. Date: Sep. 6, 2012

(54) METHOD AND SYSTEM FOR PROVIDING USER CONTROL OF TWO-DIMENSIONAL IMAGE DEPTH WITHIN THREE-DIMENSIONAL DISPLAY SPACE

(75) Inventors: Gabor Sines, Toronto (CA); Pavel Siniavine, Richmond Hill (CA); Jitesh Arora, Markham (CA); Alexander Zorin, Aurora (CA); Xingping Cao, Markham (CA); Philip Swan, Richmond Hill (CA)

(73) Assignee: ATI Technologies ULC, Markham (CA)

(21) Appl. No.: 13/040,987

(22) Filed: Mar. 4, 2011

(51) Int. Cl. G06T 15/00

(52) U.S. Cl. 345/419

(57) ABSTRACT

A system and method for providing user control of the projection of two-dimensional (2D) image information within the three-dimensional (3D) display space of a 3D-capable display device. Advantageously, the system and method disclosed herein allow a user to view 3D video even when the source video includes 2D content, by allowing the user to adjust the z-axis position of the 2D content, thereby causing the 2D content to be projected at a user-specified image depth within 3D space. The user can adjust the z-axis position of the 2D content in real time while contemporaneously viewing the imagery, e.g., via a remote control, and such adjustment can be stored for later use when similar or other 2D content is being viewed.

### FIELD OF THE DISCLOSURE

The present disclosure relates to three-dimensional (3D) stereoscopic video systems, and in particular, to such methods and systems providing user control of image projection depth.

### BACKGROUND OF THE DISCLOSURE

Even as 3D video gains in popularity and becomes increasingly available, significant amounts of two-dimensional (2D) video will continue to exist and be produced. As a result, both 3D and 2D video content will be produced, broadcast, stored and distributed for viewing for some time to come. For example, even during an exclusively 3D video broadcast of a television program, one or more commercial breaks may be broadcast in 2D, or the viewer may switch to a 2D channel while “channel surfing” during a commercial. Similarly, chapters of a 3D recorded video, e.g., Blu-Ray, such as the credits or copyright information may only be in 2D. Hence, an exclusively 3D viewing experience cannot be guaranteed.

Accordingly, it would be desirable to allow for control by the viewer to enjoy a consistent 3D viewing experience notwithstanding inclusion of 2D content coming from the video source.

### BRIEF DESCRIPTION OF THE DRAWINGS

FIG. 1 depicts a 3D display space of a 3D-capable video display.

FIG. 2 is a functional block diagram of a system for providing user control of the projection depth of 2D imagery within a 3D display space.

FIG. 3 is a functional block diagram of an alternative embodiment of a system for providing user control of the projection depth of 2D imagery within a 3D space.

FIG. 4 is a functional block diagram of an exemplary embodiment of memory and video processor circuitry for providing user control of the projection depth of 2D imagery within a 3D space.

FIG. 5 is a functional block diagram of an exemplary embodiment of a system for providing user control of the projection depth of 2D imagery within a 3D space.

FIG. 6 is a flowchart depicting user control of the projection depth of 2D imagery within a 3D space in accordance with another embodiment.

FIG. 7 depicts use of a user-controlled device and its interaction with a display device for controlling the projection depth of 2D imagery within a 3D space in accordance with another embodiment.

### SUMMARY OF EMBODIMENTS OF THE INVENTION

Briefly in one embodiment system and method provides user control of the projection of 2D image information within the 3D display space of a 3D-capable display device. Advantageously, the system and method disclosed herein allow a user to view 3D video even when the source video includes 2D content, by allowing the user to adjust the z-axis position of the 2D content, thereby causing the 2D content to be projected at a user-specified image depth within 3D space. The user can adjust the z-axis position of the 2D content in real time while contemporaneously viewing the imagery, e.g., via a remote control, and such adjustment can be stored for later use when similar or other 2D content is being viewed.

In accordance with one embodiment, a method includes accessing depth control data related to a projection depth of two-dimensional (2D) imagery within a three-dimensional (3D) space, and processing 2D video representing a 2D image in accordance with the depth control data to provide 3D video including the 2D image projected into the 3D space.

In accordance with another embodiment, an apparatus including circuitry includes control circuitry and video processing circuitry. The control circuitry is for accessing depth control data related to a projection depth of two-dimensional (2D) imagery within a three-dimensional (3D) space. The video processing circuitry is for processing 2D video representing a 2D image in accordance with the depth control data to provide 3D video including the 2D image projected into the 3D space.

In accordance with another embodiment, an apparatus includes memory capable of storing executable instructions, and one or more processors operably coupled to the memory. The one or more processors are responsive to the executable instructions by accessing depth control data related to a projection depth of two-dimensional (2D) imagery within a three-dimensional (3D) space, and processing 2D video representing a 2D image in accordance with the depth control data to provide 3D video including the 2D image projected into the 3D space.

### DETAILED DESCRIPTION OF PREFERRED EMBODIMENTS

The following detailed description is of example embodiments of the presently claimed invention with references to the accompanying drawings. Such description is intended to be illustrative and not limiting with respect to the scope of the present invention. Such embodiments are described in sufficient detail to enable one of ordinary skill in the art to practice the subject invention, and it will be understood that other embodiments may be practiced with some variations without departing from the spirit or scope of the subject invention.

Throughout the present disclosure, absent a clear indication to the contrary from the context, it will be understood that individual circuit elements as described may be singular or plural in number. For example, the terms “circuit” and “circuitry” may include either a single component or a plurality of components, which are either active and/or passive and are connected or otherwise coupled together (e.g., as one or more integrated circuit chips) to provide the described function. Additionally, the term “signal” may refer to one or more currents, one or more voltages, or a data signal. Within the drawings, like or related elements will have like or related alpha, numeric or alphanumeric designators. Further, while the present invention has been discussed in the context of implementations using discrete electronic circuitry (preferably in the form of one or more integrated circuit chips), the functions of any part of such circuitry may alternatively be implemented using one or more appropriately programmed processors, depending upon the signal frequencies or data rates to be processed. Moreover, to the extent that the figures illustrate diagrams of the functional blocks of various embodiments, the functional blocks are not necessarily indicative of the division between hardware circuitry. Thus, for example, one or more of the functional blocks (e.g., processors, memories, etc.) may be implemented in a single piece of hardware (e.g., a general purpose signal processor, random access memory, hard disk drive, etc.). Similarly, any programs described may be standalone programs, may be incorporated as subroutines in an operating system, may be functions in an installed software package, etc.

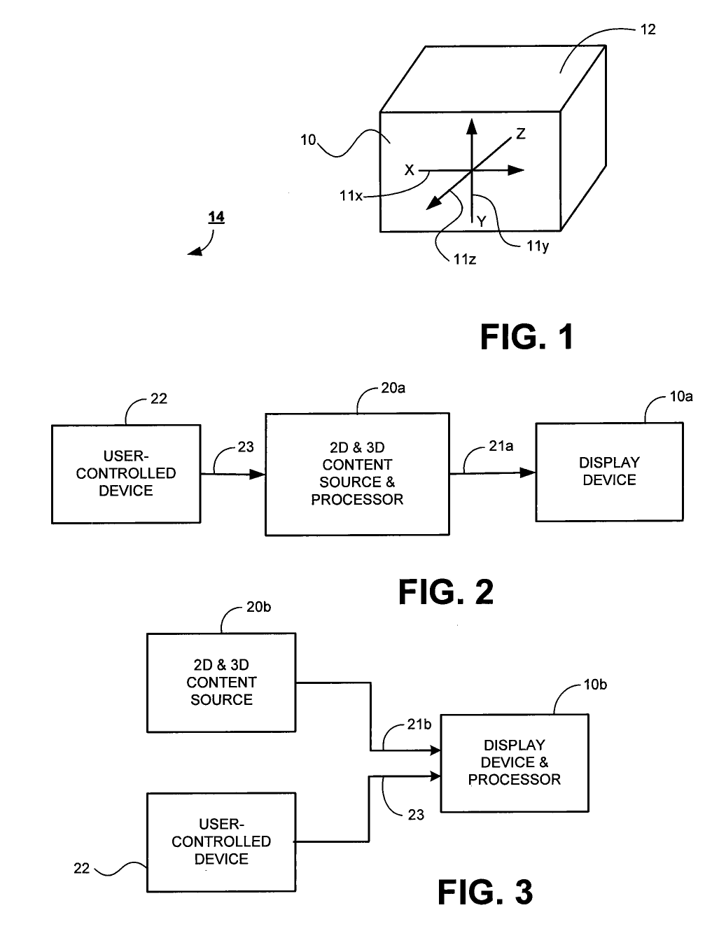

Referring to FIG. 1, a 3D-capable display device 10 provides a 3D display space 12 for viewing by a user 14. As is well known, such 3D display space 12 allows for the display and projection of 3D video content for which each picture element (pixel) is positioned somewhere along an x-axis 11x, a y-axis 11y and a z-axis 11z. Currently, when video content is displayed in such a device 10, as the video stream being displayed switches from 3D to 2D, most displays 10 simply display the 2D content on the screen along some predetermined or fixed position on the z-axis 11z. However, given that the user 14 was previously viewing 3D content, this may not provide the most desirable viewing experience. A better solution would be to provide control by the user 14 to adjust the depth, i.e., the position along the z-axis 11z, of the 2D content such that it can be made to appear closer to or further from the viewer 14 within the 3D space 12. In other words, the 2D content remains intact as 2D image information, e.g., as a 2D frame, and is projected, in accordance with the user control, along the z-axis to make it appear closer to or further from the viewer.

Referring to FIG. 2, a system for providing such control in accordance with one embodiment includes a content source and processor 20a, which provides the 2D and 3D video content, subject to control by a user-controlled device 22, which provides depth control data 23. As will be readily appreciated, the content source and processor 20a can include any of many typical sources of video content, such as a set-top box, a video disc player, a gaming console, a video recording system, a personal computer, or a network device, such as a router or a switch (wired or wireless) via which content is received from a remote source via a network. The status of the content as 3D or 2D is determined and encoded appropriately upstream, e.g., by the provider of the original content when making it available for broadcast or other forms of distribution, and is readily recognized, e.g., based on differences in 3D and 2D encoding. As will be further appreciated, the user-controlled device can be any among typical devices such as a remote control (e.g., radio frequency or infrared), computer keyboard or computer mouse (discussed in more detail below).

In accordance with the depth control data 23 provided by user-controlled device 22, the processor within the content source and processor 20a processes 2D video content to provide corresponding 3D video 21a for display by a display device 10a. It would be readily appreciated that the display device 10a can include such typical display devices as a flat panel display or a video projector.

Referring to FIG. 3, in accordance with another embodiment, processing of the 2D content in accordance with the depth control data 23 provided by the user-controlled device 22 can be performed within a display device 10b having its own video processor. Accordingly, the video content source 20b provides the 2D content 21b for processing within such display device and processor 10b in accordance with the depth control data 23.

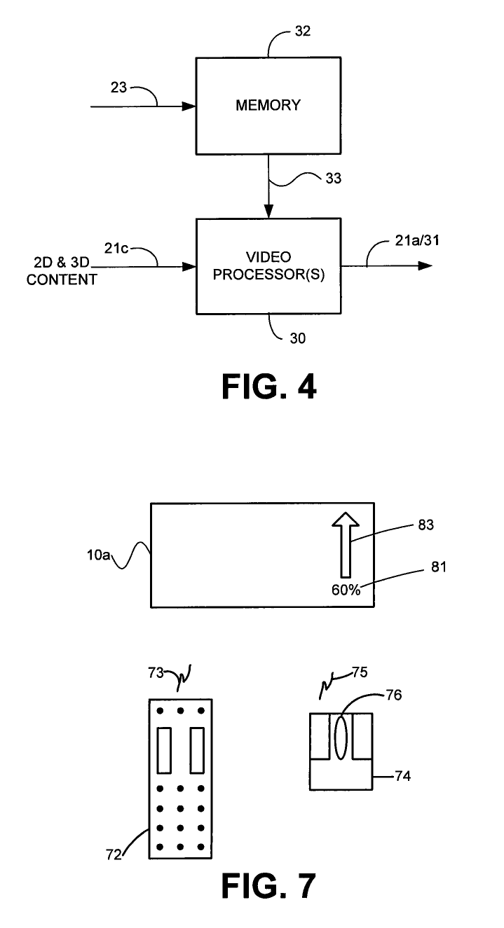

Referring to FIG. 4, in accordance with another embodiment, the processing circuitry for processing the video content 21c can include one or more video processors 30 and memory circuitry 32. Such memory circuitry 32 can include any form of suitable memory, such as volatile, non-volatile, flash, random access, read only, programmable read only, and magnetic media. Such one or more video processors 30 can include any suitable form of processing circuitry, such as microprocessors, graphics processors or digital signal processors.

The memory circuitry 32 can be programmed in accordance with the depth control data 23 provided by the user-controlled device 22, and provide executable instructions 33 for the one or more video processors 30, which then provide 3D video 21a/31 corresponding to the original 2D video.

Such user control of the projection depth of the 2D imagery within the 3D display space 12 can be done in real time by the user, or can be stored within the system, such as in the memory 32, for later use whenever such 2D imagery is received for processing and display within a 3D space 12.

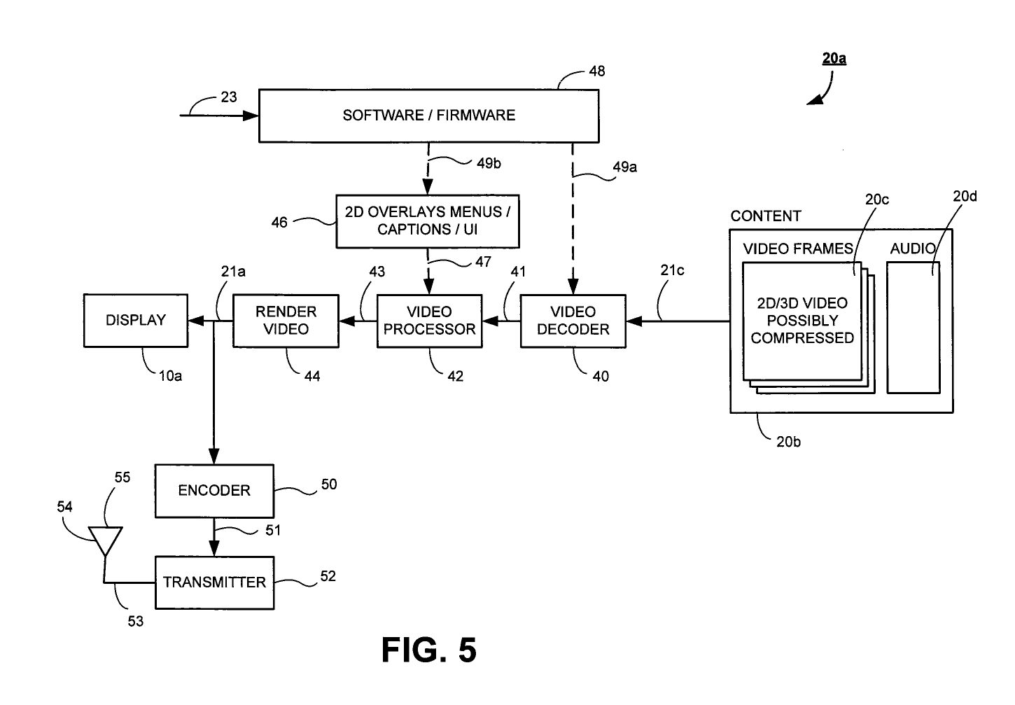

Referring to FIG. 5, another example embodiment of a system 20a providing user control of the projection depth of 2D imagery within a 3D space can include a content source 20b, via which video 20c and audio 20d are provided. The video 21c is decoded by a video decoder 40 in accordance with well known principles and techniques using instructions and control data 49a available from software and/or firmware 48, e.g., stored locally within the system or available remotely via a network.

The decoded video is processed by a video processor 42. Additional instructions and control data 49b provided by the software and/or firmware 48, using control data 23 (e.g., Z-position data) received from a user-controlled device 22 (FIG. 2), are provided to a 2D overlay generator 46 which, in accordance with well known principles and techniques, can provide menus, captions and user interface content 47 for processing with the decoded video 41 by the video processor 42 in accordance with well known principles and techniques. For example, such menus, captions or user interface content 47 can be blended with the 3D content so as to appear part of the 3D space.

The resulting processed video 43 is further processed by a video rendering engine 44 in accordance with well known principles and techniques to produce the final 3D video data 21a to be displayed by the display device 10a (e.g., autosteroscopic, anaglyph, polarization or frame sequential with active shutter glasses, among others known in the art).

Alternatively, the final 3D video data 21a can be made available for distribution to one or more other display devices (not shown). For example, the data 21a can be encoded with a conventional video encoder 50. The encoded video data 51 can then be processed by a conventional transmitter 52, e.g., converted to a radio frequency signal 53 for transmission via an antenna 54 as a wireless signal 55.

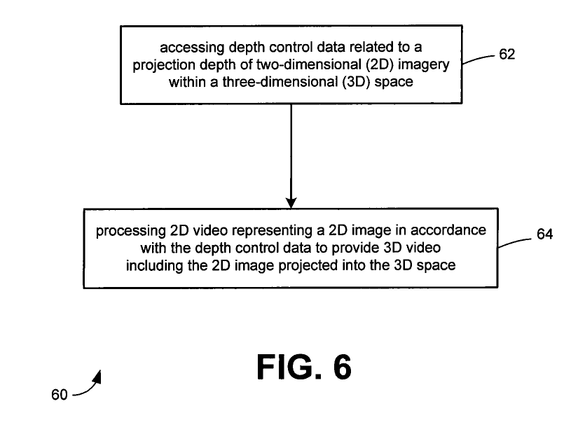

Referring to FIG. 6, an exemplary embodiment of a method for controlling the projection depth of 2D imagery within a 3D space begins with a step 62 of accessing depth control data related to a projection depth of 2D imagery within a 3D space. This is followed by another step 64 of processing 2D video representing a 2D image in accordance with the depth control data to provide 3D video including the 2D image projected into the 3D space.

Referring to FIG. 7, as discussed above, a user-controlled device 22 (FIG. 2) allows the user to interactively, e.g., with the display device 10a, control the projection depth of the 2D imagery within the 3D space. Examples, among others, can include a wireless remote control 72 or a wireless computer pointing device (e.g., “mouse”) 74, which transmit wireless signals 73, 75 (e.g., radio frequency or infrared) for reception by the content source and processor 20a (FIGS. 2 and 5) to control the projection depth. For example, the channel or volume up and down buttons on the remote control 73 can be pressed or the scrolling wheel 76 on the pointing device 74 can be rotated to adjust the projection depth. User feedback indicative of the projection depth can be provided by the content source and processor 20a in the form of a user interface displayed on the display device 10a, e.g., in the form of numerical indicia 81 or a graphical representation 83 of the projection depth.

Various other modifications and alternations in the structure and method of operation of this invention will be apparent to those skilled in the art without departing from the scope and the spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A method comprising:
responsive to depth control data related to a projection depth of two-dimensional (2D) imagery within a three-dimensional (3D) space, processing 2D video representing a 2D image in accordance with said depth control data to provide 3D video including said 2D image projected into said 3D space at said projection depth.

2. The method of claim 1, wherein said accessing depth control data comprises receiving said depth control data via a user-controlled device.

3. The method of claim 1, wherein said accessing depth control data comprises retrieving said depth control data from memory.

4. The method of claim 1, wherein said depth control data represents a user-specified image depth within said 3D space.

5. The method of claim 1, further comprising displaying said 3D video with said 2D image projected into said 3D space at said projection depth.

6. The method of claim 1, further comprising encoding said 3D video, with said 2D image projected into said 3D space at said projection depth, for transmission.

7. An apparatus including circuitry, comprising:
control circuitry for responsive to depth control data related to a projection depth of two-dimensional (2D) imagery within a three-dimensional (3D) space, video processing circuitry for processing 2D video representing a 2D image in accordance with said depth control data to provide 3D video including said 2D image projected into said 3D space at said projection depth.

8. The apparatus of claim 7, wherein said control circuitry comprises a user-controlled device via which a user can provide said depth control data.

9. The apparatus of claim 7, wherein said control circuitry comprises memory circuitry.

10. The apparatus of claim 7, wherein said depth control data represents a user-specified image depth within said 3D space.

11. The apparatus of claim 7, further comprising a display for displaying said 3D video with said 2D image projected into said 3D space at said projection depth.

12. The apparatus of claim 7, further comprising an encoder for encoding said 3D video, with said 2D image projected into said 3D space at said projection depth, for transmission.

13. An apparatus, comprising:
memory capable of storing executable instructions; and
one or more processors operably coupled to said memory and responsive to said executable instructions by
responsive to depth control data related to a projection depth of two-dimensional (2D) imagery within a three-dimensional (3D) space, processing 2D video representing a 2D image in accordance with said depth control data to provide 3D video including said 2D image projected into said 3D space at said projection depth.

14. The apparatus of claim 13, wherein said accessing depth control data comprises receiving said depth control data via a user-controlled device.

15. The apparatus of claim 13, wherein said accessing depth control data comprises retrieving said depth control data from memory.

16. The apparatus of claim 13, wherein said depth control data represents a user-specified image depth within said 3D space.

17. The apparatus of claim 13, further comprising a display for displaying said 3D video with said 2D image projected into said 3D space at said projection depth.

18. The apparatus of claim 13, further comprising an encoder for encoding said 3D video, with said 2D image projected into said 3D space at said projection depth, for transmission.
